(19) United States
(12) Patent Application Publication
(10) Pub. No.: US 2003/0094553 A1
(43) Pub. Date: May 22, 2003

(54) Tree-mounted device for supporting animals and method of use

(76) Inventor: Frederick James Mullis, Troy, AL (US)

Correspondence Address: CLARK & BRODY, Suite 600, 1750 K Street, NW, Washington, DC, 20006, US

(21) Appl. No.: 10/191,055

(22) Filed: Jul. 10, 2002

Related U.S. Application Data
(60) Provisional application No. 60/331,439, filed on Nov. 16, 2001.

(51) Int. Cl. A47B 96/06; A47G 29/00; A47K 1/00; E04G 5/06; E04G 3/00; F21V 21/00; F21V 35/00

(52) U.S. Cl. 248/219.4; 248/230.8

(57) ABSTRACT

A device for suspending animals after a hunt includes a pair of legs, and means for mounting the device to an upright member. One leg is used to suspend or hang the animal, and the other leg has a serrated member, which secures the device from lateral and vertical motion when in place. A brace can be used to provide further support for suspension of animals, and the device can be made collapsible for ease of transport and storage.

This application claims priority under 35 USC 119(e) based on provisional application no. 60/331,439 filed on Nov. 16, 2001.

### FIELD OF THE INVENTION

The present invention is directed to a tree-mounted device for suspending animals, and in particular, to a device that uses an existing tree for suspending purposes.

### BACKGROUND ART

In hunting lodges, a variety of structures, e.g., “meat poles” or the like, are employed outside the lodge to allow hunters to suspend animals upon returning from a hunt. Often times, there are not enough poles to accommodate all of the hunters and hunters are left with no means to suspend their animals.

One solution is to merely use an existing tree providing that the tree has a branch that is low enough to the ground to be used and is sturdy enough to support the weight of the animal. In these instances, a rope can be thrown over the branch, and the animal can be hung using the rope.

However, in many instances, there are not enough trees with low branches to suspend all of the animals that have been hunted and killed. Consequently, there is a need to provide other means to suspend animals obtained through hunting.

Another solution proposed in the prior art is a right-angled pole that is supported by the hitch mechanism on a vehicle. While these devices provide relief where there are insufficient poles for suspending game, the presence of a vehicle is still needed, and where vehicle access is limited, this solution is not effective.

The present invention solves the deficiencies in the prior art by supplying a device that can be attached to any tree trunk or other upright member, and is capable of supporting animals of great weight. Furthermore, the device, in one embodiment, is portable and can be easily transported in the folded-up position.

### SUMMARY OF THE INVENTION

It is a first object of the present invention to provide an improved suspending device for animals downed by hunting.

Another object of the invention is to provide a suspending device that does not need any branches and uses the weight of the animal to assist in securing the device to a tree or other structure.

A still further object of the invention is a suspending device that can be compacted for easy transport and storage.

Other objects and advantages of the present invention will become apparent as a description thereof proceeds.

In satisfaction of the foregoing objects and advantages, the present invention provides a device for suspending an animal off the ground that utilizes an upright member such as a tree or the like. The device comprises a frame that is generally l-shaped with two legs. One free end of a first leg has a means to support an animal, with an end of the other leg having a member with serrations or other protrusions that would extend into the upright member once the weight of the animal is placed on the free end of the first leg. The serrations are positioned generally transverse or laterally to an axis of the other leg to provide sway resistance of the device when mounted. A brace is optionally positioned between the two legs. Also provided is means for holding or securing a junction point of the legs or one of the legs to the upright member.

The holding means can be a strap or cable sized to extend around the upright member and be secured thereto. The serrated member can be a plate welded to the end of the other leg. The serrations can be formed in the plate itself or be a separate element or elements. Preferably, the serrated member has a curved or angled surface designed to wrap around a cylindrical upright member such as a tree when the device is in use. The supporting means can be a loop or hook extending from the end of the first leg for animal suspension, wherein a line or other flexible element can engage the loop/hook and be secured to the animal.

The device can be made collapsible by having the two legs pivot with respect to each other. When using a brace, the brace can be attached so that it can pivot with respect to one of the legs, or be completely removable.

The invention also includes a method of suspending an animal from the ground using an upright member. The frame and leg assembly described above is mounted to an upright member such as a tree by securing the junction of the legs, or one or both legs thereto. Once mounted, an animal can be suspended from the one leg. This application of weight to the device drives or forces the other leg against the upright member. The serrations or other pointed extensions dig or bite into the upright member to keep the device stable. When the device is made collapsible, the legs, and brace can be folded up prior to the need for suspending an animal. The legs and brace, if present, can then be unfolded and mounted on the desired structure. Once the need for suspension of the animal is complete, the device can be removed from the upright member, collapsed, and stored until another use is desired.

### BRIEF DESCRIPTION OF THE DRAWINGS

Reference is now made to the drawings of the invention wherein:

FIG. 1 shows a perspective view of one embodiment of the invention;

FIG. 2 shows the embodiment of FIG. 1 in an exemplary use; and

FIG. 3 shows another embodiment of the invention.

### DESCRIPTION OF THE PREFERRED EMBODIMENTS

The present invention offers significant improvements in suspending of animals in conjunction with hunting. The inventive suspending device is easily mounted to any tree and does not require any branches or other means for animal support. Further, the device uses the weight of the animal to assist in stabilizing the device once the animal is hung. The invention is especially useful in places where there is a lack of stands or other structures that can be readily used to suspend an animal.

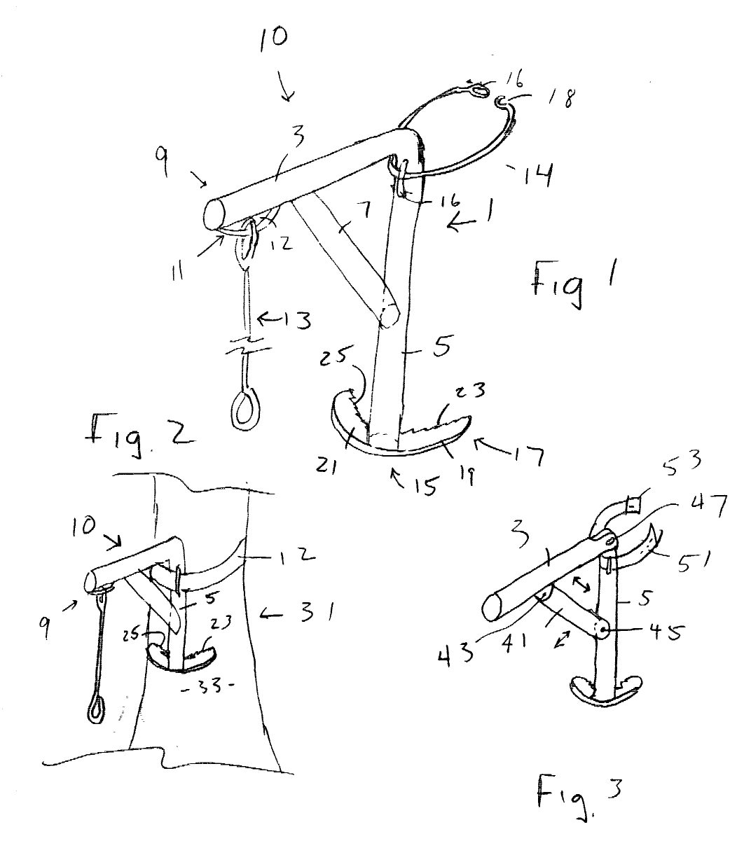

Referring now to FIGS. 1 and 2, the suspending device is generally designated by the reference numeral 10 and is seen to include an L-shaped frame 1 having a pair of legs 3 and 5. A brace 7 extends between the legs to provide structural support. The brace is preferably welded to the legs, but other attachment means can be employed such as fasteners if desired. In yet another mode, the brace could be removably attached to both legs so that the one pivotal attachment is not needed. In this mode, the brace would be installed between the two legs using fasteners or the like for the desired structural rigidity. In yet another mode, for lightweight duty, the brace could be eliminated and the legs themselves could be used to support the weight of an animal.

Positioned at the end 9 of leg 3 is a means for supporting an animal, a member 11 shown with an opening 12. The opening 12 is designed to support an animal using the illustrated line 13, or any other type of an animal support. While a loop type structure is shown, a hook or other type of a support can be employed at any part of the end 9. A hoist can also be used in connection with the device by hooking one end of the hoist to the member 11, and using the hoist to raise the animal, and then suspending the animal using the line 13.

At the junction of the legs 3 and 5 is a cable or strap 14, which is sized to wrap around a tree and secure the leg 5 thereagainst. The cable can be secured to either leg 3 or 5 in any way, and can be any type of strap that can adjust to the diameter of the tree, e.g., one with a buckle, or through the mere use of two free ends that are knotted. The illustrated cable 14 is held to leg 5 using a loop 16 and uses a hook 18 for securement purposes. While the cable 14 is shown as a continuous piece, it could be made into two pieces, with one end of each piece secured to the frame. The cable length can be adjustable for different tree diameters by using any known means. Moreover, as a means for mounting or securing the device to the upright member, the strap could be mounted to the leg at a distance from the junction, or more than one strap could be used. In yet another mode and while a preferred embodiment, the device could be mounted by using leg 3 instead of leg 5. In this mode, the leg 3 would need a surface that the strap could rest on when cinched around the tree. For example, the leg 3 could employ a plate extending from the leg, the plate having a surface that the strap could interface with for cinching purposes.

A serrated plate-like member 17 is located at free end 15 of the leg 5. The serrated member 17 has two leg portions 19 and 21 that are angled with respect to each other so that the respective serrations 23 and 25 face the tree. The angling can vary, but is preferably between 90 and 180 degrees. Alternatively, the portions 19 and 21 could form a curved edge rather than an angled edge. While the member 17 is shown in a plate-like configuration, any member having serrations that would be angled or curved to dig into a tree when the suspending device is in place is within the scope of the invention. The serrations can vary in spacing and depth. For example, instead of a number of adjacent serrations, the member 17 could employ spaced apart spikes or the like to grab onto and/or penetrate the tree or other upright member. The member 17 can be a one-piece design cut from a plate of steel, or be two pieces if desired. The member 17 can be attached to the end 15 in any way but is preferably welded thereto.

FIG. 2 shows the device in an exemplary use. The strap 12 wraps around the tree 31. The serrations 23 and 25 are adjacent the tree bark 33. When an animal is hung from end 9, the leg 5 is forced against the tree 31, causing the serrations 23 and 25 to dig into the tree bark 33. This assists in preventing the device 10 from sliding or swaying around the circumference of the tree 31 as well as up and down along the tree trunk length.

The device 10 is fairly compact so that it is not too cumbersome to use or carry in the embodiment shown in FIGS. 1 and 2.

In another mode, the junction of the two legs and the brace could pivot or fold for storage, transport, and set up. This embodiment 10′ is shown in FIG. 3 wherein the brace 41 pivots at point 43, and is secured to leg 5 at point 45. The legs pivot with respect to each other at 47. To dismantle the device, the brace 41 could be unsecured at 45 and pivoted so that it is generally parallel to leg 3. The leg 5 could then pivot freely toward leg 3 to provide a more compact device for storage and transport. Of course, other pivoting arrangements could be used as well so that the legs pivot between a storage position where the legs would be folded and an operative position wherein the legs would be spaced apart for use. Any means may be used to secure the brace 41 in the operative position such as a butterfly nut or the like.

FIG. 3 also shows a strap 51 in place of the cable 14 of FIGS. 1 and 2. The strap can be adjustable with a buckle 53 or could use free ends and knotting to secure to the tree. In fact, any type of cinching of the strap, cable or other flexible member to an upright member can be employed to mount the device. It should be understood that any type of strap or cable or other type of a flexible member is within the scope of the invention, including the means to secure the cable ends together and means to provide length adjustability, e.g., a buckle or the like.

The frame 1 can be made of any material, but it is preferred to make it from a steel rod material such as 34 inch rod. This material would have sufficient strength to support a heavy animal of the end 9.

While the device is primarily disclosed for use with a tree, and particularly a tree trunk, the device is adapted for use with any upright member that allows the device to be secured thereto. For example, a wooden pole such as a telephone pole could be used instead of a tree trunk.

As such, an invention has been disclosed in terms of preferred embodiments thereof which fulfills each and every one of the objects of the present invention as set forth above and provides new and improved suspending device for an animal.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. An upright member suspending device comprising;
a frame that is generally 1-shaped with two legs, one free end of a first leg having a means to support an animal; an end of the other leg having a member with serrations, the serrations generally transverse to an axis of the other leg;
an optional brace positioned between the two legs; and
a means for holding a junction point of the legs or one of the legs to the upright member.

2. The device of claim 1, wherein the holding means is a strap or cable sized to extend around the upright member and be secured thereto.

3. The device of claim 1, wherein the member with serrations is a plate welded to the end of the other leg.

4. The device of claim 1 wherein the supporting means is a loop extending from the end of the first leg.

5. The device of claim 4, further comprising a line designed to engage the loop, the line adapted to be attached to the animal.

6. The device of claim 1, wherein the two legs are pivotal with respect to each other and the brace is pivotal with respect to one of the legs.

7. The device of claim 1, wherein the frame is made from a steel rod.

8. The device of claim 1, wherein the member with serrations has a curved or angled surface from which the serrations extend from that is sized to wrap around a portion of the upright member when the device is in use.

9. A method of suspending an animal on an upright member comprising:
providing a frame that is generally 1-shaped with two legs, one free end of a first leg having a means to support an animal; an end of the other leg having a serrated member, the serrations generally transverse to an axis of the other leg, an optional brace positioned between the two legs; and a means for holding a junction point of the legs or one of the legs to the upright member;
mounting the device to the upright member; and
suspending an animal from the supporting means, the suspending step forcing the other leg against the upright member so that the serrations dig into the upright member.

10. The method of claim 9, wherein one end of the device is mounted by cinching a strap around the upright member.

11. The method of claim 9, wherein the two legs are pivotal with respect to each other, and the brace is pivotal with respect to one of the legs, and further comprising storing the device by folding the legs toward each other, and folding the brace with respect to one leg.

12. The method of claim 9, wherein the device is mounted to a tree trunk.

13. The method of claim 9, wherein the device uses the brace.

14. The device of claim 1, wherein the device uses the brace.
